(19) United States
(12) Patent Application Publication
(10) Pub. No.: US 2026/0241536 A1
(43) Pub. Date: Aug. 20, 2026

(54) MOTORCYCLE LIFT ADAPTER

(71) Applicant: Ryan A. Border, Ogden, UT (US)

(72) Inventor: Ryan A. Border, Ogden, UT (US)

(21) Appl. No.: 19/058,531

(22) Filed: Feb. 20, 2025

(51) Int. Cl. B25H 1/00; B66F 7/24

(52) U.S. Cl. CPC B25H 1/0014; B66F 7/243

(57) ABSTRACT

A motorcycle lift adapter may include a platform configured to support a motorcycle. A motorcycle lift adapter may include a plurality of lift supports configured to secure the platform to a first lift arm of a first lift post and a second lift arm of a second lift post. A motorcycle lift adapter may include a plurality of wheels secured to the platform.

### BACKGROUND

Many people desire to work on motorcycles. For example, people like to perform maintenance, make improvements, clean, or otherwise work on motorcycles. When working on a motorcycle, an individual may desire to raise the height of the motorcycle, to improve the ease of visibility and/or access of certain portions of the motorcycle.

### BRIEF SUMMARY

In some aspects, the techniques described herein relate to a motorcycle lift adapter for a car lift. The car lift includes a first lift post and a second lift post. The motorcycle lift adapter includes a platform configured to support a motorcycle. A plurality of lift supports are configured to secure the platform to a first lift arm of a first lift post and a second lift arm of a second lift post. A plurality of wheels are secured to the platform.

In some aspects, the techniques described herein relate to a method for securing a motorcycle to a car lift. An operator may load a motorcycle onto a platform of a motorcycle lift adapter. The operator may roll the motorcycle lift adapter between a first lift post and a second lift post of the car lift such that a longitudinal axis of the motorcycle lift adapter is approximately aligned between the first lift post and the second lift post. With the motorcycle lift adapter approximately aligned at the car lift, the operator may rotate a first lift arm and a second lift arm of the first lift post and a third lift arm and a fourth lift arm of the second lift post into a lifting configuration with respect to the motorcycle lift adapter.

In some aspects, the techniques described herein relate to a motorcycle lift system. The motorcycle lift system includes a motorcycle lift adapter. The motorcycle lift adapter includes a platform configured to support a motorcycle, a plurality of lift supports secured to the platform, and a plurality of wheels secured to the platform. A car lift includes a first lift post including a first lift arm and a second lift arm, the first lift arm and the second lift arm rotatable with respect to the first lift with an axis of rotation parallel to a force of gravity. A second lift post includes a third lift arm and a fourth lift arm, the third lift arm and the fourth lift arm rotatable with respect to the first lift with an axis of rotation parallel to the force of gravity. The first, second, third, and fourth lift arms are configured to connect to the platform at the plurality of lift supports when the motorcycle lift adapter is aligned between the first lift post and the second lift post.

This summary is provided to introduce a selection of concepts that are further described below in the detailed description. This summary is not intended to identify key or essential features of the claimed subject matter, nor is it intended to be used as an aid in limiting the scope of the claimed subject matter. Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1-1 and FIG. 1-2 are schematic representations of a motorcycle lift system, according to at least one embodiment of the present disclosure.

FIG. 2-1 through FIG. 2-4 are a series of schematic diagrams of a motorcycle lift system, according to at least one embodiment of the present disclosure.

FIG. 3-1 through FIG. 3-4 are representations of a motorcycle lift adapter, according to at least one embodiment of the present disclosure.

FIG. 4 is a side view of a representation of a motorcycle lift adapter, according to at least one embodiment of the present disclosure.

FIG. 5 is a side view of a representation of a motorcycle lift adapter, according to at least one embodiment of the present disclosure.

FIG. 6 is a flowchart of a method for securing a motorcycle to a car lift, according to at least one embodiment of the present disclosure.

### DETAILED DESCRIPTION

This disclosure generally relates to devices, systems, and methods for a motorcycle lift adapter for use on a car lift. A motorcycle lift adapter includes a platform. A motorcycle may be rolled onto the platform. Wheels may be connected to the platform. With the motorcycle secured to the platform, the motorcycle and the motorcycle lift adapter may be moved within a workspace, such as a shop or other workspace. The motorcycle and motorcycle lift adapter may be rolled on the wheels between two lift posts of a car lift and aligned with the two lift posts. For example, the longitudinal axis of the motorcycle lift adapter may be aligned with the two lift posts. The lift arms of the car lift may be rotated toward and secured to the motorcycle lift adapter. Both lift posts of the car lift may then lift the motorcycle and the motorcycle lift adapter. In this manner, the motorcycle lift adapter may easily and stably allow a user to mount the motorcycle on the motorcycle lift adapter, maneuver the motorcycle lift adapter and motorcycle into place, and lift the motorcycle and motorcycle lift adapter to facilitate easy access to the motorcycle for maintenance, improvements, and other operations.

Typically, to raise the height of a motorcycle for ease of maintenance, a user may utilize a specialized motorcycle lift. However, such specialized motorcycle lifts may be expensive and/or single-purpose devices. Some users may have a car lift, which includes two lift posts spaced apart. Lift arms on the lift posts may extend under a car to engage with the frame of the car. The lift posts may include actuators that may cause the lift arms to raise in height, thereby lifting the car by the frame. However, such car lifts are not configured to lift a motorcycle. For example, maneuvering the motorcycle between the lift posts is impractical or impossible for a single user based on the weight of the motorcycle and the positioning of the lift posts. Further, the lift arms are not sized or configured to lift the motorcycle.

Conventionally, a car lift may be adapted for use with a motorcycle by fixing a platform to the lift arms of one of the lift posts. The motorcycle may be rolled onto the platform, with the longitudinal axis of the motorcycle perpendicular to the lift posts, after the platform is secured to the lift arms. The single lift post may then raise the lift arms, and the motorcycle with them. However, such a connection to a car lift may limit access to one side of the motorcycle, as that side of the motorcycle will face the lift post, with the lift post blocking view and/or access to the motorcycle. Further, such a connection to a car lift may cause uneven loading of the car lift, which may reduce the operation and/or increase repair and maintenance costs.

In accordance with at least one embodiment of the present disclosure, a motorcycle lift adapter may connect to both lift posts of a car lift. The motorcycle may be oriented on the motorcycle lift adapter such that the longitudinal axis of the motorcycle is aligned with the two lift posts. Put another way, the front wheel of the motorcycle may be located next to a first lift post, and the rear wheel of the motorcycle may be located to a second lift post. This may facilitate access to both sides of the motorcycle. Further, this may result in even or relatively even loading of the two lift posts when they lift the motorcycle and the motorcycle lift adapter.

As discussed in further detail herein, the motorcycle may be loaded on the motorcycle lift adapter when the motorcycle lift adapter is not connected to the car lift. For example, the motorcycle lift adapter may include a platform supported by wheels. The motorcycle may be rolled onto the platform when the motorcycle lift adapter is located away from the lift arms of the car lift. With the motorcycle loaded on the platform, and secured to the platform, the motorcycle lift adapter, with the loaded motorcycle, may be rolled, using the wheels supporting the platform, into position between the two lift posts, including both translating and rotating the relative orientation of the motorcycle with respect to the lift posts. This may increase the ease of positioning and loading/unloading the motorcycle on the car lift.

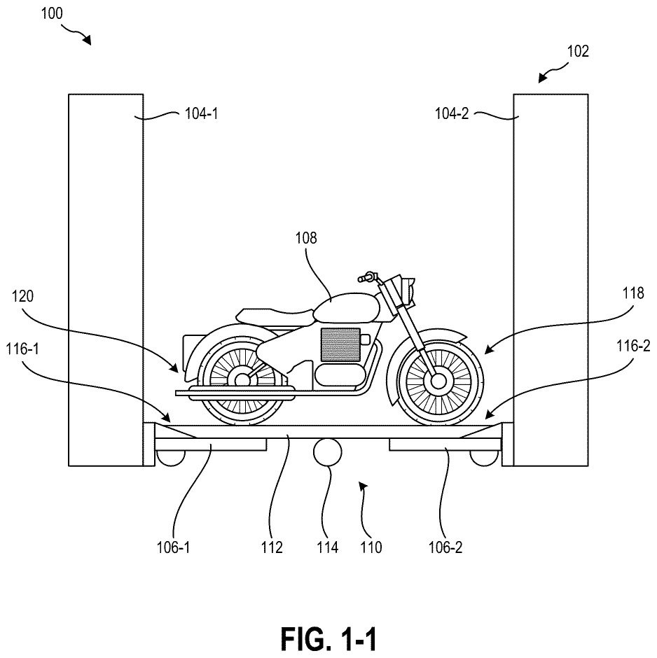

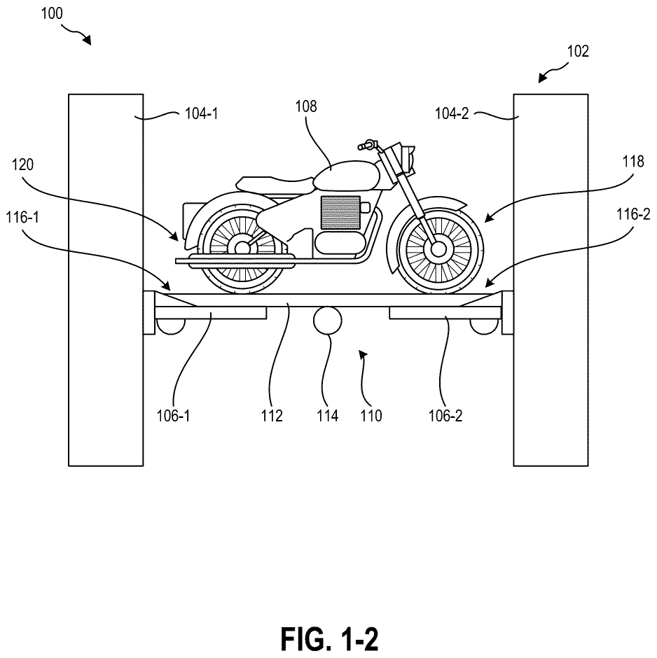

FIG. 1-1 is a representation of a motorcycle lift system 100, according to at least one embodiment of the present disclosure. The motorcycle lift system 100 includes a car lift 102. The car lift 102 includes a first lift post 104-1 and a second lift post 104-2. The first lift post 104-1 includes a first lift arm 106-1 and the second lift post 104-2 includes a second lift arm 106-2. A motorcycle 108 is loaded on a motorcycle lift adapter 110.

The motorcycle lift adapter 110 includes a platform 112 supported by multiple wheels 114. The platform 112 may support the motorcycle 108. Put another way, the motorcycle 108 may be rolled onto the platform 112. The lift arms 106 may be configured to support the motorcycle lift adapter 110. For example, the motorcycle lift adapter 110 may extend between the first lift post 104-1 and the second lift post 104-2. The first lift arm 106-1 may be located at a first end 116-1 of the motorcycle lift adapter 110 and the second lift arm 106-2 may be located at a second end 116-2 of the motorcycle lift adapter 110. The motorcycle lift adapter 110 may structurally support the motorcycle 108 such that when the first lift post 104-1 and the second lift post 104-2 lift the first lift arm 106-1 and the second lift arm 106-2, the first lift arm 106-1 and the second lift arm 106-2 may lift the motorcycle lift adapter 110, which may lift the motorcycle 108.

As may be seen, the motorcycle 108 may be aligned with the car lift 102. For example, the longitudinal axis of the motorcycle 108 (e.g., the axis from a front wheel 118 to a rear wheel 120, the line the front wheel 118 and the rear wheel 120 make while driving) may extend between the first lift post 104-1 and the second lift post 104-2 such that the longitudinal axis of the motorcycle 108 may extend through both the first lift post 104-1 and the second lift post 104-2. Put another way, and in the embodiment shown, the front wheel 118 may be closer to the second lift post 104-2 and the rear wheel 120 may be closer to the first lift post 104-1. However, it should be understood that the motorcycle 108 may have a different orientation, such that the front wheel 118 may be closer to the first lift post 104-1 and the rear wheel 120 may be closer to the second lift post 104-2. In some embodiments, the front wheel 118 may be located over the second lift arm 106-2 (or the first lift arm 106-1 in a different orientation) and the rear wheel 120 may be located over the first lift arm 106-1 (or the second lift arm 106-2 in a different orientation). As discussed herein, this may facilitate even, or approximately even, loading of the first lift post 104-1 and the second lift post 104-2. Further, this may facilitate access to both sides of the motorcycle 108 without the first lift post 104-1 or the second lift post 104-2 blocking or otherwise obstructing the view of or access to the side of the motorcycle 108.

To move the motorcycle 108 loaded on the motorcycle lift adapter 110, a user may push the motorcycle lift adapter 110 and motorcycle 108 such that the motorcycle lift adapter 110 rolls on the wheels 114. The wheels 114 may be configured or structured to roll in 360°. For example, the wheels 114 may include castor wheels that are mounted with a 360° swivel bearing. In some examples the wheels 114 may include omnidirectional wheels. In some examples, the wheels 114 may include roller balls. In some examples, the wheels 114 may include any type of wheel that facilitate multi-directional movement of the wheels 114 and the platform 112 supported by the wheels 114.

As discussed in further detail herein, the motorcycle 108 may be loaded on the motorcycle lift adapter 110 may be loaded when the motorcycle lift adapter 110 is located away from the car lift 102. For example, the motorcycle 108 may be loaded on the motorcycle lift adapter 110 when the motorcycle lift adapter 110 is not aligned with the car lift 102 and/or is remote from the car lift 102. When the motorcycle 108 is loaded on the motorcycle lift adapter 110, the user may roll the motorcycle lift adapter 110, including the motorcycle 108, next to the car lift 102 and align the motorcycle lift adapter 110 with the first lift post 104-1 and the second lift post 104-2. This may enable improve ease of operation and loading/unloading of the motorcycle 108 on the car lift 102.

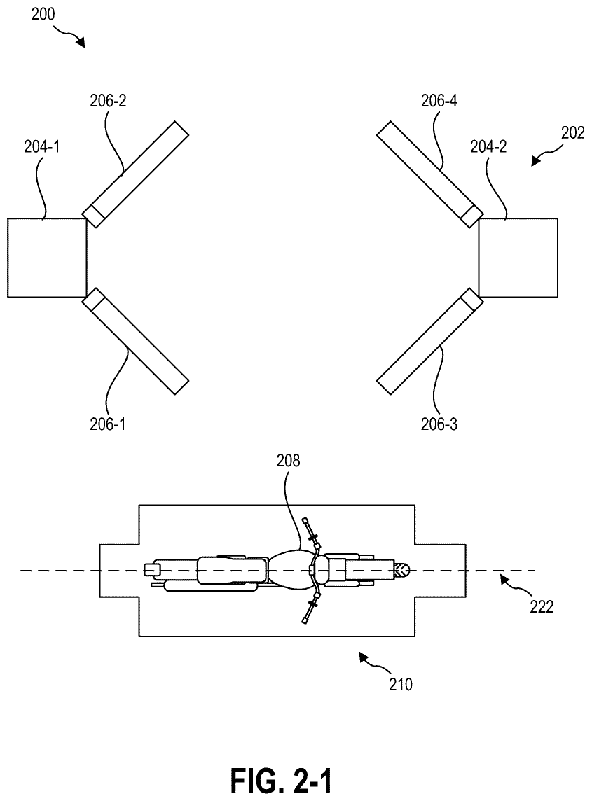

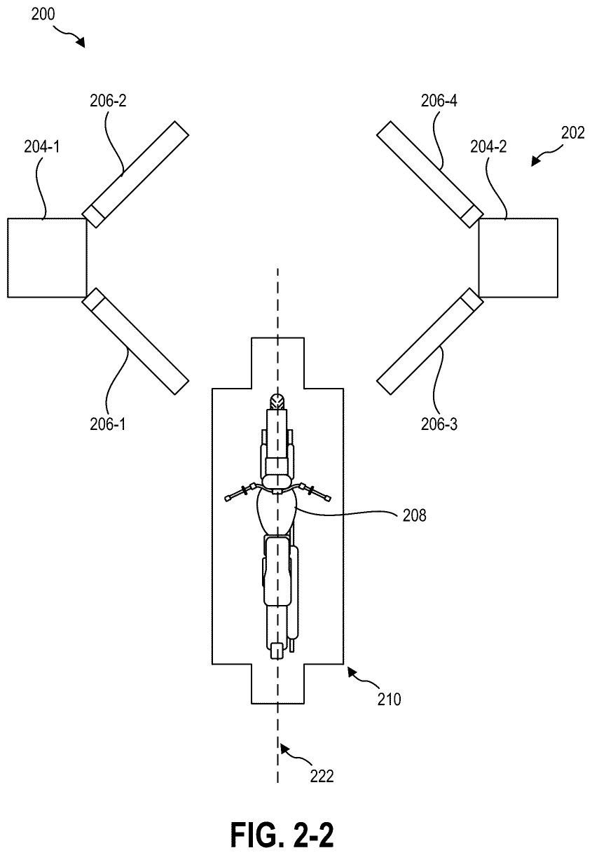

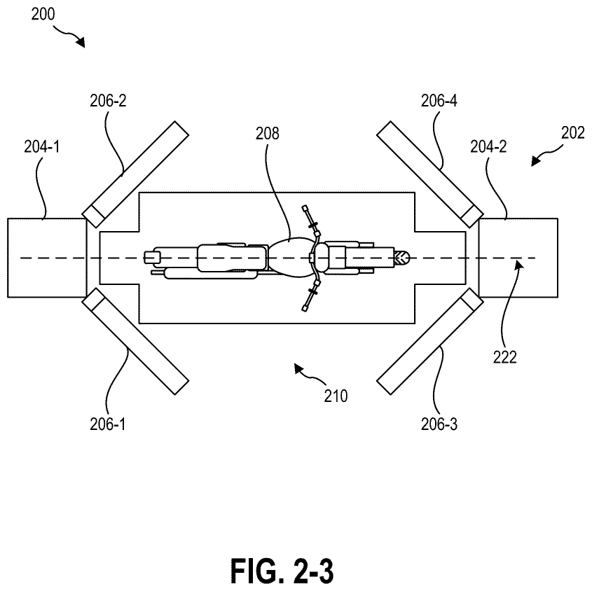

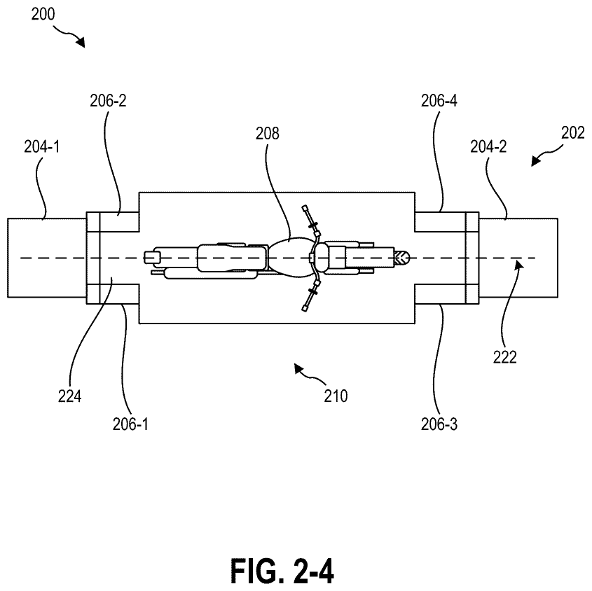

In FIG. 1-2, the motorcycle 108 has been lifted. To lift the motorcycle 108, the first lift post 104-1 and the second lift post 104-2 may include actuators, such as hydraulic, pneumatic, electric, or mechanical actuators. The actuators in the first lift post 104-1 and the second lift post 104-2 may cause the first lift arm 106-1 and the second lift arm 106-2 to raise up. The first lift arm 106-1 and the second lift arm 106-2 may engage a bottom surface of the platform 112. As discussed herein, the platform 112 may have sufficient structural strength (such as through one or more braces or other support members) that when the first lift arm 106-1 and the second lift arm 106-2 are lifted, the first lift arm 106-1 and the second lift arm 106-2 lift the platform 112, and the motorcycle 108 secured thereon. In this manner, the motorcycle lift system 100 may facilitate the loading, positioning, lifting, and unloading of the motorcycle 108. In some embodiments, the lifted motorcycle lift adapter 110 may provide an elevated storage solution for the motorcycle 108 and/or provide an elevated work bench or working surface.

FIG. 2-1 through FIG. 2-4 are a series of schematic diagrams of a motorcycle lift system 200 illustrating the loading of a motorcycle 208 on a motorcycle lift adapter 210 and the positioning of the motorcycle 208 and the motorcycle lift adapter 210 with respect to a car lift 202, according to at least one embodiment of the present disclosure. In FIG. 2-1, the motorcycle 208 is loaded on the motorcycle lift adapter 210. In the embodiment shown, the motorcycle lift adapter 210 is not aligned with the car lift 202. For example, a longitudinal axis 222 of the motorcycle lift adapter 210 may not intersect any portion of the car lift 202. In some examples, the longitudinal axis 222 may not intersect one or both of a first lift post 204-1 or a second lift post 204-2 of the car lift 202. In some examples, the motorcycle lift adapter 210 may not be located with the space outlined by a set of lift arms (collectively 206) of the car lift 202. For example, the lift arms 206 may not overlap, contact, or otherwise interfere with the loading of the motorcycle 108 on the motorcycle lift adapter 210. While the discussion with respect to FIG. 2-1 has described loading the motorcycle 208 on the motorcycle lift adapter 210 in a particular orientation, it should be understood that the techniques of the present disclosure may be applied to loading the motorcycle 208 in any orientation with respect to the car lift 202.

Loading the motorcycle 208 on the motorcycle lift adapter 210 away from the car lift 202 may improve the ease of loading of the motorcycle 208. In some embodiments, loading the motorcycle 208 on the motorcycle lift adapter 210 away from the car lift 202 may improve the loading operation's safety by reducing obstructions or other hazards from the loading area.

As discussed herein, the motorcycle lift adapter 210 is supported by multiple wheels. The wheels may enable the motorcycle lift adapter 210 to roll on the ground in the space of the motorcycle lift system 200. Indeed, the wheels may facilitate manual pushing and rolling of the motorcycle lift adapter 210 by a single user, or by a small group of two or three users, without significant exertion. Car lifts 202 are often located in a shop, a garage, or other area that has space on at least one side of the car lift 202. Indeed, for a car to be loaded on the car lift 202, the car lift 202 may have an access space through which the car may access the car lift 202. The motorcycle 208 may be loaded on the motorcycle lift adapter 210 in the access space to the car lift 202. Because motorcycles are typically smaller than cars, the motorcycle lift adapter 210, including the loaded motorcycle 208, may have room to maneuver using the supporting wheels. This may allow the remote loading of the motorcycle 208 and subsequent positioning of the motorcycle lift adapter 210 with respect to the car lift 202.

In FIG. 2-2, the motorcycle lift adapter 210, including the loaded motorcycle 208, has been moved from the position illustrated in FIG. 2-1. Moving the motorcycle lift adapter 210 has changed the position of the longitudinal axis 222 with respect to the lift posts 204 of the car lift 202. The motorcycle lift adapter 210 may be reoriented and moved with respect to the position illustrated in FIG. 2-1 to facilitate positioning at the car lift 202.

To move the motorcycle lift adapter 210 into a lifting configuration at the car lift 202, the lift arms 206 of the lift posts 204 may be rotated outwards from the lift posts 204. For example, a first lift arm 206-1 and a second lift arm 206-2 of the first lift post 204-1 may be rotated away from the lifting space between the first lift post 204-1 and the second lift post 204-2. Similarly, a third lift arm 206-3 and a fourth lift arm 206-4 of the second lift post 204-2 may be rotated away from the lifting space between the first lift post 204-1 and the second lift post 204-2. The lift arms 206 may have a rotational axis that is parallel to the force of gravity. Rotating the lift arms 206 away from the lift posts 204 may allow the user to maneuver and position the motorcycle lift adapter 210 between the first lift post 204-1 and the second lift post 204-2. While the embodiment of FIG. 2-2 illustrates the lift arms 206 as open with a particular angle, it should be understood that the range of motion of the lift arms 206 may be greater or less than that illustrated, based on the specifications of the car lift 202.

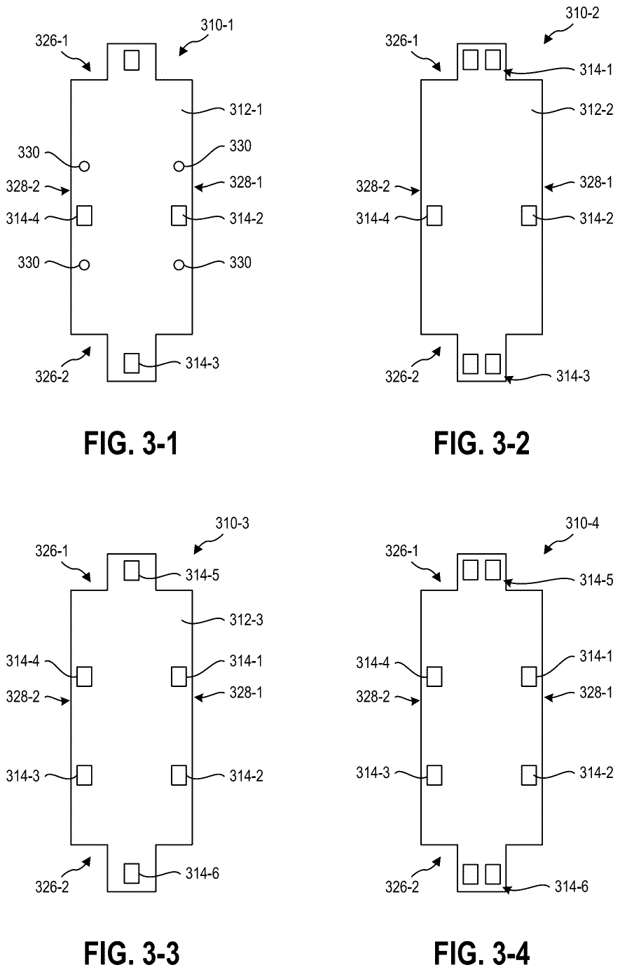

In FIG. 2-3, the motorcycle lift adapter 210 has been moved between the first lift post 204-1 and the second lift post 204-2. In the position shown, the motorcycle lift adapter 210 is aligned, or substantially aligned, between the first lift post 204-1 and the second lift post 204-2. For example, the motorcycle lift adapter 210 is aligned or substantially aligned with the lift posts 204 when the longitudinal axis 222 intersects both the first lift post 204-1 and the second lift post 204-2. In some examples, the motorcycle lift adapter 210 is aligned with the lift posts 204 with the longitudinal axis 222 intersects the first lift post 204-1 and the second lift post 204-2 at their center.

As discussed above, the lift arms 206 may be rotated away from the lift posts 204 to enable the motorcycle lift adapter 210 to be positioned between the lift posts 204. When the motorcycle lift adapter 210 is positioned between the lift posts 204, the lift arms 206 may be rotated inward toward the motorcycle lift adapter 210, as shown in FIG. 2-4. In the view shown in FIG. 2-4, the motorcycle lift system 200 has been moved into the lifting configuration, with the motorcycle lift adapter 210 aligned with the lift posts 204 and the lift arms 206 have been rotated inward toward the space between the lift posts 204.

As the lift arms 206 are rotated inward, the lift arms 206 may be positioned to engage the motorcycle lift adapter 210. For example, in the embodiment shown, the lift arms 206 may be rotated underneath the motorcycle lift adapter 210 In this manner, as the lift arms 206 are lifted, the lift arms 206 may lift the motorcycle lift adapter 210 from underneath. However, it should be understood that the lift arms 206 may be located above the motorcycle lift adapter 210. For example, the lift arms 206 may be inserted into clips, loops, or brackets located on an upper surface of the motorcycle lift adapter 210. In some embodiments, the lift arms 206 may be extendable. For example, the lift arms 206 may include telescoping booms that may extend outward from their respective lift posts 204. This may enable the lift arms 206 to be inserted in or through a clip, loop, or bracket of the motorcycle lift adapter 210.

In the lifting configuration illustrated in FIG. 2-4, the lift arms 206 may be rotated fully inward. For example, the lift arms 206 may be rotated inward such that the first lift arm 206-1 is parallel or substantially parallel to the second lift arm 206-2 and the third lift arm 206-3 is parallel or substantially parallel to the fourth lift arm 206-4. Further, in the lifting configuration illustrated, the first lift arm 206-1 may be aligned or substantially aligned with the third lift arm 206-3, and the second lift arm 206-2 may be aligned or substantially aligned with the fourth lift arm 206-4. This may facilitate or encourage stability in lifting of the motorcycle lift adapter 210 by the car lift 202.

In some embodiments, the lift arms 206 may be secured to the motorcycle lift adapter 210. For example, the lift arms 206 may be secured to the motorcycle lift adapter 210 using a mechanical fastener, such as a bolted connection, a threaded rod and nuts, pin and cotters, straps, retaining tabs, any other secured connection, and combinations thereof. Put another way, the lift arms 206 may be bolted to the motorcycle lift adapter 210 to secure the motorcycle lift adapter 210 to the car lift 202. The lift arms 206 may be bolted to motorcycle lift adapter 210 in any manner. For example, the lift arms 206 may be bolted to an underside of the motorcycle lift adapter 210. In some examples, the lift arms 206 may be bolted to one or more structural supports on the underside of the motorcycle lift adapter 210. In some examples, the lift arms 206 may be bolted to the motorcycle lift adapter 210 through a platform of the motorcycle lift adapter 210. In some examples, the motorcycle lift adapter 210 may include a nut welded or otherwise secured to the motorcycle lift adapter 210. Securing the lift arms 206 to the motorcycle lift adapter 210 may improve the stability and security of the motorcycle lift adapter 210. This may improve the safety of the motorcycle lift system 200 by reducing or preventing accidental or unintended slipping of the motorcycle lift adapter 210 with respect to the lift arms 206.

In accordance with at least one embodiment of the present disclosure, the motorcycle lift adapter 210 includes a guide 224. The guide 224 may facilitate alignment of the motorcycle lift adapter 210 within the car lift 202. For example, the guide 224 may be positioned or arranged such that the lift arms 206, when rotated inward, may contact the motorcycle lift adapter 210 at the guide 224. When the first lift arm 206-1 and the second lift arm 206-2 engage the guide 224 in the view shown, this may center the motorcycle lift adapter 210 between the first lift arm 206-1 and the second lift arm 206-2, thereby aligning the motorcycle lift adapter 210 with the lift posts 204. In some embodiments, the motorcycle lift adapter 210 may include a single guide. In some embodiments, the motorcycle lift adapter 210 may include a guide on either longitudinal end of the motorcycle lift adapter 210. This may further enable or facilitate the alignment of the motorcycle lift adapter 210 with the lift posts 204. Aligning the motorcycle lift adapter 210 with the lift posts 204 may facilitate even loading of the car lift 202, thereby reducing wear and tear on the car lift 202 due to uneven loading.

FIG. 3-1 through FIG. 3-3 illustrate representations of a motorcycle lift adapter 310, according to at least one embodiment of the present disclosure. In FIG. 3-1, a first motorcycle lift adapter 310-1 includes a first platform 312-1 and multiple wheels (collectively 314). The wheels 314 are spaced around the first platform 312-1 in a pattern to provide support for the first motorcycle lift adapter 310-1. In the embodiment shown, a first wheel 314-1 is located at a first longitudinal end 326-1 of the first motorcycle lift adapter 310-1, a second wheel 314-2 is located at a first lateral end 328-1 of the first motorcycle lift adapter 310-1, a third wheel 314-3 is located at a second longitudinal end 326-2 of the first motorcycle lift adapter 310-1, and a fourth wheel 314-4 is located at a second lateral end 328-2 of the first motorcycle lift adapter 310-1. The second wheel 314-2 and the fourth wheel 314-4 may be centered or approximately centered between the first longitudinal end 326-1 and the second longitudinal end 326-2. In this configuration, the wheels may form a diamond shape, which may increase the stability of the first motorcycle lift adapter 310-1 when a motorcycle is loaded thereon. In the embodiment shown, the first wheel 314-1 and the third wheel 314-3 may be located in the guide portion of the first motorcycle lift adapter 310-1.

The first motorcycle lift adapter 310-1 may include lift supports (collectively 330). The lift supports 330 may be the portion or portion of the first motorcycle lift adapter 310-1 to which the lift arms may be connected. For example, the lift supports 330 may include the bolts, bolt holes, structural supports, and so forth to which the lift arms may connect. In the embodiment shown, the lift supports 330 may be located with respect to the second wheel 314-2 and the fourth wheel 314-4 so that the lift arms may rotate toward the first motorcycle lift adapter 310-1 without contacting or interfering with the second wheel 314-2 and the fourth wheel 314-4.

In FIG. 3-2, a second motorcycle lift adapter 310-2 includes a second platform 312-2 and multiple wheels (collectively 314). The wheels 314 are spaced around the second platform 312-2 in a pattern to provide support for the second motorcycle lift adapter 310-2. In the embodiment shown, a first wheel set 314-1 includes two wheels located at a first longitudinal end 326-1 of the second motorcycle lift adapter 310-2, a second wheel 314-2 is located at a first lateral end 328-1 of the second motorcycle lift adapter 310-2, a third wheel set 314-3 is located at a second longitudinal end 326-2 of the second motorcycle lift adapter 310-2, and a fourth wheel 314-4 is located at a second lateral end 328-2 of the second motorcycle lift adapter 310-2. The second wheel 314-2 and the fourth wheel 314-4 may be centered or approximately centered between the first longitudinal end 326-1 and the second longitudinal end 326-2. The first wheel set 314-1 and the second wheel set 314-2 may include two or more wheels. This may further increase the stability of the second motorcycle lift adapter 310-2.

In FIG. 3-3, a third motorcycle lift adapter 310-3 includes a third platform 312-3 and multiple wheels (collectively 314). The wheels 314 are spaced around the first platform 312-1 in a pattern to provide support for the third motorcycle lift adapter 310-3. In the embodiment shown, a first wheel 314-1 and a second wheel are located at a first lateral end 328-1 of the third platform 312-3 and a third wheel 314-3 and a fourth wheel are located at a second lateral end 328-2 of the third platform 312-3. The first wheel first wheel 314-1, second wheel 314-2, third wheel 314-3, and fourth wheel 314-4 may form a square or a rectangle on or at the third platform 312-3. A fifth wheel 314-5 may be located at the first longitudinal end 326-1 of the third motorcycle lift adapter 310-3 and a sixth wheel 314-6 may be located at the second longitudinal end 326-2 of the third motorcycle lift adapter 310-3. The fifth wheel 314-5 and the sixth wheel 314-6 may provide longitudinal stability for the third motorcycle lift adapter 310-3.

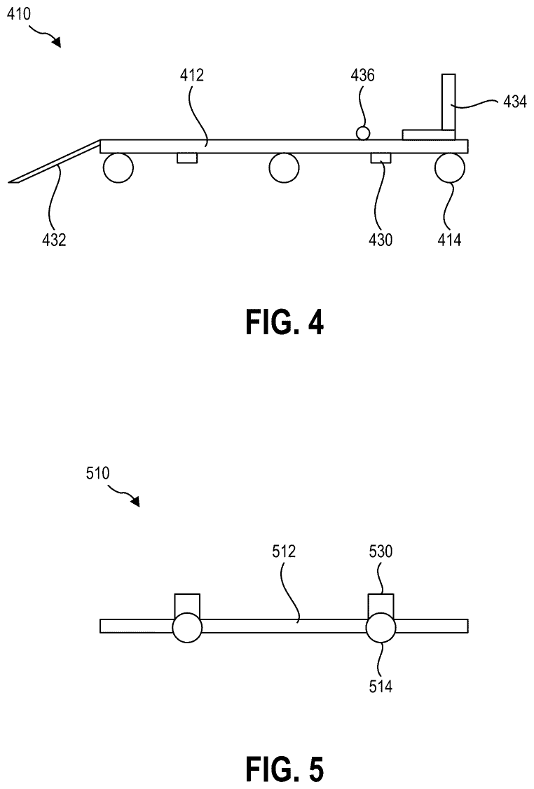

In FIG. 3-4, a fourth motorcycle lift adapter 310-4 includes a fourth platform 312-4 and multiple wheels. The wheels 314 are spaced around the first platform 312-1 in a pattern to provide support for the fourth motorcycle lift adapter 310-4. In the embodiment shown, a first wheel 314-1 and a second wheel are located at a first lateral end 328-1 of the fourth platform 312-4 and a third wheel 314-3 and a fourth wheel are located at a second lateral end 328-2 of the fourth platform 312-4. The first wheel first wheel 314-1, second wheel 314-2, third wheel 314-3, and fourth wheel 314-4 may form a square or a rectangle on or at the fourth platform 312-4. A fifth wheel set 314-5 including two or more wheels may be located at the first longitudinal end 326-1 of the fourth motorcycle lift adapter 310-4 and a sixth wheel set 314-6 including two or more wheels may be located at the second longitudinal end 326-2 of the fourth motorcycle lift adapter 310-4. The fifth wheel set 314-5 and the sixth wheel set 314-6 may provide longitudinal stability for the fourth motorcycle lift adapter 310-4 and added stability at the first longitudinal end 326-1 and the second longitudinal end 326-2.

While the embodiments of FIG. 3-1 through FIG. 3-4 illustrate wheels 314 arranged around a perimeter of the platform 312, it should be understood that the techniques of the present disclosure may include additional wheels. For example, the motorcycle lift adapters 310 of the present disclosure may include additional wheels 314 located around the perimeter, or between the lateral ends 328 and the longitudinal ends 326. In at least one embodiment, the additional wheels 314 may be aligned approximately along the longitudinal axis of the motorcycle lift adapter 310, or halfway between the first lateral end 328-1 and the second lateral end 328-2. Such additional wheels on the interior of the platform 312 may increase the structural stability of the motorcycle lift adapter 310 and/or improve the rolling stability of the motorcycle lift adapter.

FIG. 4 is a side view of a representation of a motorcycle lift adapter 410, according to at least one embodiment of the present disclosure. The motorcycle lift adapter 410 includes a platform 412 supported by wheels 414. The motorcycle lift adapter 410 further includes lift supports 430 secured to a bottom surface of the platform 412. The lift supports 430 may be connectable to lift arms of a car lift to lift the motorcycle lift adapter 410.

In the embodiment shown in FIG. 4, the motorcycle lift adapter 410 includes an attached loading ramp 432. The loading ramp 432 may be selectively removable to a longitudinal end 426 of the motorcycle lift adapter 410. For example, the attached loading ramp 432 and the platform 412 may include complementary hooks or other fasteners to secure the loading ramp 432 and the platform 412 to each other and prevent relative movement of the platform 412 and the loading ramp 432 while loading a motorcycle on the motorcycle lift adapter 410. To load a motorcycle on the motorcycle lift adapter 410, the user may roll the motorcycle up the loading ramp 432 and onto the platform 412. In some embodiments, one or more of the wheels 414 may be a locking wheel. While loading the motorcycle, the locking wheel may be locked to prevent movement of the motorcycle lift adapter 410. The motorcycle lift adapter 410 may be secured to prevent motion during loading with a locking mechanism in any other manner. For example, the locking mechanism may include extendable feet, in which the motorcycle lift adapter 410 may be at least partially lifted off the ground (such as by 0.125 in. or 0.25 in.) with a foot-extending mechanism, such as an electric linear actuator, a pneumatic or hydraulic actuator, or mechanical lever.

When the motorcycle is loaded on the motorcycle lift adapter 410, a wheel of the motorcycle may be secured to the platform 412 in a motorcycle securing element 434. The motorcycle securing element 434 may include one or more of locking wheels, a wheel chock, a wheel vise, tie downs, a biker bar or other frame connection point, or other securing elements suitable for securing the motorcycle to the platform 412. The motorcycle lift adapter 410 may further include one or more tie-down points 436. A user may further secure the motorcycle to the motorcycle lift adapter 410 by securing a tie down (e.g., a ratchet strap, rope, chain, come along, cable puller) to the motorcycle and the tie-down point 436. This may facilitate a secure and robust attachment of the motorcycle to the motorcycle lift adapter 410, thereby reducing or preventing the chance of knocking the motorcycle over while moving the motorcycle lift adapter 410.

FIG. 5 is a side view of a representation of a motorcycle lift adapter 510, according to at least one embodiment of the present disclosure. The motorcycle lift adapter 510 includes a platform 512 supported by wheels 514. The motorcycle lift adapter 510 further includes lift supports 530 secured to an upper surface of the platform 512. The lift supports 530 may be connectable to lift arms of a car lift to lift the motorcycle lift adapter 510.

In the embodiment shown, the lift supports 530 include brackets or loops into which the lift arms may be inserted. Indeed, as discussed herein, the lift arms may include an expandable boom or arm. When the lift arms are rotated into position, the expandable boom or arm may be extended into the lift supports 530. Locating the lift supports 530 on top of the platform 512 may allow the profile of the motorcycle lift adapter 510 to be lower. This may reduce the size of a loading ramp, or eliminate the need of a loading ramp altogether.

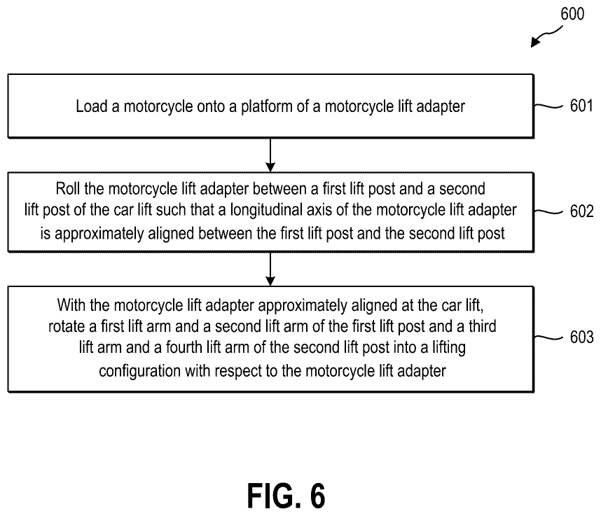

FIG. 6 is a flowchart of a method 600 for securing a motorcycle to a car lift, according to at least one embodiment of the present disclosure. An operator may load a motorcycle onto a platform of a motorcycle lift adapter at 601. The operator may roll the motorcycle lift adapter between a first lift post and a second lift post of the car lift such that a longitudinal axis of the motorcycle lift adapter is approximately aligned between the first lift post and the second lift post at 602. With the motorcycle lift adapter approximately aligned at the car lift, the operator may rotate a first lift arm and a second lift arm of the first lift post, and a third lift arm and a fourth lift arm of the second lift post into a lifting configuration with respect to the motorcycle lift adapter at 603.

In some embodiments, the operator may further secure the motorcycle to the platform with a motorcycle securing element, such as a wheel chock, a wheel vise, tie downs, a biker bar or other frame connection point, or other securing elements suitable for securing the motorcycle to the platform, and combinations thereof. In some embodiments, the operator may, in the lifting configuration, bolt the first, second, third, and fourth lift arms to the platform. In some embodiments, loading the motorcycle on the motorcycle lift adapter includes loading the motorcycle when the motorcycle lift adapter is not aligned with the first lift post and the second lift post.

As discussed herein, in the lifting configuration, rotating the lift arms in toward the motorcycle lift adapter may align the motorcycle lift adapter between the first lift post and the second lift post. For example, the lift arms may align a guide at the lift posts. In some embodiments, in the lifting configuration, the first lift arm is approximately parallel to the second lift arm, the third lift arm is approximately parallel to the fourth lift arm, the first lift arm is approximately aligned with the third lift arm, and the second lift arm is approximately aligned with the fourth lift arm.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A motorcycle lift adapter for a car lift, the car lift including a first lift post and a second lift post, comprising:
a platform configured to support a motorcycle;
a plurality of lift supports configured to secure the platform to a first lift arm of a first lift post and a second lift arm of a second lift post; and
a plurality of wheels secured to the platform.

2. The motorcycle lift adapter of claim 1, wherein the plurality of lift supports are located on a bottom surface of the platform.

3. The motorcycle lift adapter of claim 1, further comprising structural supports located on a bottom surface of the platform, wherein the structural supports include the plurality of lift supports.

4. The motorcycle lift adapter of claim 1, wherein the plurality of lift supports include a secured connection to affix the platform to the first lift arm and the second lift arm.

5. The motorcycle lift adapter of claim 1, wherein the plurality of wheels include a first wheel located at a first longitudinal end of the platform, a second wheel located at a second longitudinal end of the platform, a third wheel located at a first lateral end of the platform, and a fourth wheel located at second lateral end of the platform.

6. The motorcycle lift adapter of claim 5, further comprising a fifth wheel located at the first longitudinal end of the platform and a sixth wheel located at the second longitudinal end of the platform.

7. The motorcycle lift adapter of claim 1, wherein the plurality of wheels are located on a bottom surface of the platform.

8. The motorcycle lift adapter of claim 1, wherein the plurality of wheels include castor wheels having 360° of rotation.

9. The motorcycle lift adapter of claim 1, wherein the plurality of wheels include omnidirectional wheels.

10. The motorcycle lift adapter of claim 1, further comprising a locking mechanism to secure the motorcycle lift adapter during loading and unloading.

11. The motorcycle lift adapter of claim 1, wherein the platform includes a guide to center the platform at the first lift post and the second lift post.

12. The motorcycle lift adapter of claim 11, wherein at least one of the plurality of wheels is secured to the platform at the guide.

13. The motorcycle lift adapter of claim 1, further comprising a loading ramp selectively removable to at least one of a first longitudinal end or a second longitudinal end of the platform.

14. The motorcycle lift adapter of claim 1, further comprising a motorcycle securing element and one or more tie-down points connected to the platform to secure the motorcycle to the platform.

15. A method for securing a motorcycle to a car lift, the method comprising:
loading a motorcycle onto a platform of a motorcycle lift adapter;
rolling the motorcycle lift adapter between a first lift post and a second lift post of the car lift such that a longitudinal axis of the motorcycle lift adapter is approximately aligned between the first lift post and the second lift post; and
with the motorcycle lift adapter approximately aligned at the car lift, rotating a first lift arm and a second lift arm of the first lift post and a third lift arm and a fourth lift arm of the second lift post into a lifting configuration with respect to the motorcycle lift adapter.

16. The method of claim 15, further comprising:
securing the motorcycle to the platform; and
in the lifting configuration, securing the first, second, third, and fourth lift arms to the platform.

17. The method of claim 15, wherein rotating the first lift arm and the second lift arm of the first lift post aligns a first longitudinal end of the motorcycle lift adapter with the first lift post.

18. The method of claim 15, wherein, in the lifting configuration, the first lift arm is approximately parallel to the second lift arm, the third lift arm is approximately parallel to the fourth lift arm, the first lift arm is approximately aligned with the third lift arm, and the second lift arm is approximately aligned with the fourth lift arm.

19. The method of claim 15, wherein loading the motorcycle onto the platform includes rolling the motorcycle onto the platform when the motorcycle lift adapter is not aligned with the first lift post and the second lift post.

20. A motorcycle lift system, comprising:
a motorcycle lift adapter, including:
a platform configured to support a motorcycle;
a plurality of lift supports secured to the platform; and
a plurality of wheels secured to the platform; and
a car lift, including:
a first lift post including a first lift arm and a second lift arm, the first lift arm and the second lift arm rotatable with respect to the first lift with an axis of rotation parallel to a force of gravity; and
a second lift post including a third lift arm and a fourth lift arm, the third lift arm and the fourth lift arm rotatable with respect to the first lift with an axis of rotation parallel to the force of gravity, wherein the first, second, third, and fourth lift arms are configured to connect to the platform at the plurality of lift supports when the motorcycle lift adapter is aligned between the first lift post and the second lift post.
